(19) United States
(12) Patent Application Publication
(10) Pub. No.: US 2014/0344146 A1
(43) Pub. Date: Nov. 20, 2014

(54) SYSTEMS AND METHODS OF MANAGING POSTPAID AND PREPAID ACCOUNTS

(71) Applicant: Yissum Strategies Ltd., Ramat-Gan (IL)

(72) Inventor: Gil Paul, Tel-Aviv (IL)

(21) Appl. No.: 14/368,839

(22) PCT Filed: Dec. 27, 2012
(86) PCT No.: PCT/IL12/50557

§ 371 Date: Jun. 26, 2014

Related U.S. Application Data
(60) Provisional application No. 61/580,754, filed on Dec. 28, 2011.

(51) Int. Cl. G06Q 20/24; G06Q 20/26; G06Q 20/28

(52) U.S. Cl. CPC G06Q 20/24; G06Q 20/28; G06Q 20/26
USPC 705/39

(57) ABSTRACT

A computerized method of managing postpaid and prepaid accounts of subscribers. The method comprises managing, for each of a plurality of subscribers, a prepaid account and a postpaid account having a common identifier, providing at least one accounts management rule, receiving payment instructions to debit or credit a first of the plurality of subscribers, the payment instructions is associated with a respective the common identifier, selecting automatically, using a processor, according to respective the at least one accounts management rule, which of respective the prepaid account and the postpaid account of the first subscriber to debit or credit according to the payment instructions, and updating the selected account according to the payment instructions.

### FIELD AND BACKGROUND OF THE INVENTION

The present invention, in some embodiments thereof, relates to account management and, more particularly, but not exclusively, to systems and methods of managing postpaid and prepaid accounts.

In today's commerce financial transactions are usually performed by debit and credit cards, also known as postpaid cards, and by prepaid cards which are loaded with resources, such as cash deposits, virtual currency, service usage credit and/or the like.

When a debit card of a debit subscriber is charged, the charge is subtracted from the bank account of the debit subscriber. Debit cards allow debit subscribers to spend only what is in their bank account. It is a quick transaction between the card holder personal bank account and the card issuer. Debit cards are a preferred substitute to checks as they reduce identification requirements at the time of the transaction. When a credit card of a credit subscriber is charged, a credit which is given to the credit subscriber is charged. Credit cards allow credit subscribers to perform financial transactions up to the limit of their credit line. Credit cards are issued by a credit card issuer, such as a bank or credit union, after an account has been approved by the credit provider, after which cardholders can use it to make purchases at merchants accepting that card. A card issued to users as a system of payment. It allows its holder to buy goods and services based on the holder's promise to pay for these goods and services.

The issuer of the card creates a revolving account and grants a line of credit to the consumer (or the user) from which the user can borrow money for payment from the issuer to pay the merchant or as a cash advance.

During the last years, cards that combine both debit and credit accounts have been developed. For example, U.S. Pat. No. 6,038,552 describes a method and apparatus for executing a transaction using a credit card includes the steps of maintaining a credit card account associated with the credit card, the credit card account having a credit limit and a transaction balance indicative of an aggregate of previously authorized transaction amounts in a predetermined period, maintaining a cash account associated with the credit card, the cash account having a cash balance, receiving a request for authorization for a new transaction amount against the credit card account in exchange for goods or services; and authorizing the requested transaction amount when the aggregate of the credit limit (line) and cash balance less the transaction balance exceeds the requested transaction amount.

As described above, an additional option for performing financial transactions is using a prepaid card, also referred to a stored-value card. This card refers to a monetary value that is not stored in an externally recorded account that can be debited without the card identifier, such as a bank account. Most prepaid cards enable the user to load money onto the card, store the money safely, and spend or withdraw the funds in a variety of ways. Prepaid cards are issued by financial institutions, carry one of the major payment network brands, and are accepted wherever those network brands are accepted, just like a debit card associated with a checking account. The features and fees associated with the cards vary widely. Examples for prepaid cards are closed loop cards, which are used for transactions exclusively at a particular merchant's locations, open loop cards, which are cards associated with a network brand, such as Visa and MasterCard, and honored the network brand debiting and/or crediting facilities, one time use cards, which are loaded only once, and reloadable cards, which are loadable with funds after an initial purchase.

### SUMMARY OF THE INVENTION

According to some embodiments of the present invention, there is provided a computerized method of managing a plurality of postpaid and prepaid accounts, comprising:

managing, for each of a plurality of subscribers, a prepaid account and a postpaid account having a common identifier;

providing at least one accounts management rule;

receiving payment instructions to debit or credit a first of the plurality of subscribers, the payment instructions is associated with a respective the common identifier;

selecting automatically, using a processor, according to respective the at least one accounts management rule, which of respective the prepaid account and the postpaid account of the first subscriber to debit or credit according to the payment instructions; and

updating the selected account according to the payment instructions.

Optionally, the common identifier is a credit card number of the postpaid account.

Optionally, the method further comprises allowing a respective subscriber of the plurality of subscribers to personalize a respective the at least one accounts management rule.

Optionally, the method further comprises identifying at least one characteristic of a respective subscriber of the plurality of subscribers and automatically personalizing a respective the at least one accounts management rule.

Optionally, the method further comprises monitoring a balance in a first of the prepaid account and the postpaid account to detect a deviation from a credit amount and automatically generating the payment instructions to debit a second of the prepaid account and the postpaid account for crediting the first of the prepaid account and the postpaid account.

Optionally, the method further comprises charging a respective the prepaid account for service usage by an associated subscriber of the plurality of subscribers.

Optionally, the prepaid account is used for as a credit account for purchasing by an associated subscriber of the plurality of subscribers in at least one preselected merchant.

Optionally, the prepaid account and the postpaid account are managed in different currencies.

Optionally, the managing further comprises managing for each of the plurality of subscribers a plurality of different prepaid accounts identified by the common identifier.

More optionally, each the prepaid account is associated with another of a plurality of merchants.

Optionally, the at least one accounts management rule comprises a conditional rule which is applied according to an analysis of a balance in at least one of the prepaid account and the postpaid account.

Optionally, the at least one accounts management rule defines which of the accounts to credit or debit according to the geographic location of a financial transaction inducing the payment instructions.

Optionally, the at least one accounts management rule defines how to split a credit or a debit among the accounts.

Optionally, the at least one accounts management rule defines which of the accounts to credit or debit according to the currency of a financial transaction inducing the payment instructions.

Optionally, the at least one accounts management rule defines which of the accounts to credit or debit according to a party of a financial transaction inducing the payment instructions.

According to some embodiments of the present invention, there is provided a payment system of managing a plurality of postpaid and prepaid accounts. The payment system comprises a subscriber database which documents a prepaid account and a postpaid account having a common identifier and at least one accounts management rule for each of a plurality of subscribers, a payment monitoring module which receives payment instructions to debit or credit a first of the plurality of subscribers the payment instructions having a respective the common identifier, and a transaction coordination module which automatically selects, according to respective the at least one accounts management rule, which of respective the prepaid account and the postpaid account of the first subscriber to debit according to the payment instructions. The selected account is updated according to the payment instructions.

Optionally, at least one of the prepaid account and the postpaid account is managed by an external service provider system, the payment system further comprises an interface which updates the selected account by transmitting a message to the service provider system over a network.

Optionally, the payment monitoring module receives the payment instructions from an external service provider system.

Optionally, the common identifier is a credit card number of the postpaid account.

Optionally, the system further comprises a user interface module which allows a respective subscriber of the plurality of subscribers to personalize a respective the at least one accounts management rule.

According to some embodiments of the present invention, there is provided a computerized method of managing a plurality of postpaid and prepaid accounts. The method comprises managing, for each of a plurality of subscribers, a prepaid account and a postpaid account having a common identifier, providing at least one accounts management rule, monitoring a balance in the prepaid account and the postpaid account, and automatically transferring resources between the prepaid account and the postpaid account according to the at least one accounts management rule.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of managing one or more postpaid accounts and one or more prepaid accounts for each of a plurality of subscribers, according to some embodiments of the present invention;

FIG. 2 is a schematic illustration of the system of FIG. 1 with an interface that allows it to manage accounts of external prepaid and/or postpaid services providers, according to some embodiments of the present invention;

FIG. 3 is a schematic illustration of a plastic transaction card that has an embedded, optionally flexible, user selection component that allows a user to select between prepaid and postpaid account, according to some embodiments of the present invention; and

FIG. 4 is a flowchart of a method of managing one or more postpaid accounts and one or more prepaid accounts for each of a plurality of subscribers, according to some embodiments of the present invention.

### DESCRIPTION OF EMBODIMENTS OF THE INVENTION

The present invention, in some embodiments thereof, relates to account management and, more particularly, but not exclusively, to systems and methods of managing postpaid and prepaid accounts.

According to some embodiments of the present invention, there are provided methods and systems of managing, for each of a plurality of subscribers, a postpaid account and a prepaid account which are associated with a common identifier, such as a credit card number or any other account number. For example, the systems may be managed by an issuer or function as a proxy that provides services to issuers. When a financial transaction is performed, the methods and systems allow automatically determining which of his accounts to debit and/or to credit according to one or more accounts management rules. The accounts management rules may be personalized for the subscriber, for example according to his inputs and/or one or more characteristics thereof. The accounts management rules may be general accounts management rules.

The accounts management rules may include rules defining when resources are transferred from one account to the other, rules defining an interest rate per account, and/or conditional rules determining which account to debit or credit according to financial transaction characteristics, such as type of transaction, currency, geographic origin, financial transaction party identity, subscriber history, subscriber predefinitions and/or the like. Additional examples are provided hereinbelow.

In use, after payment instructions to debit or credit one of the subscribers are received, one of the prepaid account and the postpaid account of the subscriber are selected according to respective accounts management rule(s). Then, instructions to update the selected account are generated and optionally forwarded to the suitable provider, for example to a service provider that provides both prepaid and postpaid services for prepaid and postpaid transactions and/or to the credit card provider, the debit card provider, and/or prepaid services provider.

According to some embodiments of the present invention, there is provided a method of managing a plurality of postpaid and prepaid accounts wherein a balance in the prepaid account and the postpaid account of each subscriber is monitored to allow automatic transfer of resources between these accounts according to one or more one accounts management rules.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

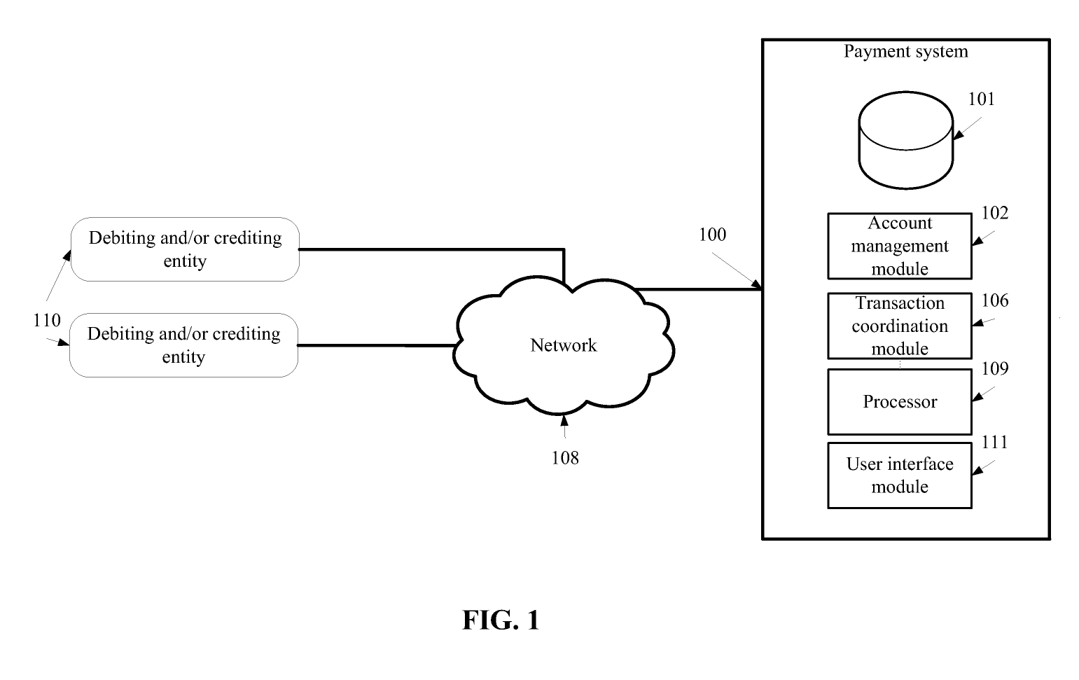

Reference is now made to FIG. 1, which is a schematic illustration of a payment system 100 of managing, for each of a plurality of subscribers, one or more postpaid accounts and one or more prepaid accounts which optionally have a common unique identifier, according to some embodiments of the present invention. For brevity, multiple prepaid accounts or multiple postpaid accounts pertaining to a single entity may be respectively referred to herein as a prepaid account and a postpaid account. The subscriber may be any account owner, for example a person or a legal entity, such as a company or a partnership. As used herein, a subscriber may be any user that financial transactions thereof are handled by the payment system 100, regardless to whether he was registered to a certain service and/or to the payment system 100. It should be noted that the components of the payment system 100 may be centralized on a central server or distributed among a plurality of servers and/or services.

Optionally, the payment system 100 manages prepaid accounts, such as bank and/or deposit accounts and postpaid accounts, such as credit card accounts and/or credit which are used for cellular electric payment (i.e. using near field communication). In such embodiments, an application hosted on a cellular phone, such as a Smartphone, for making payment may be used for crediting and/or debiting the prepaid and postpaid accounts. It should be noted that the term prepaid account and/or prepaid includes stored value card account and/or closed loop card account.

In use, the subscriber uses his cellular phone for performing prepaid and/or postpaid financial transactions. Optionally, the application allows the user to select, for some or all of the financial transactions, which account to credit and/or to debit. In such embodiments, the application may be used for adjusting the account rules and/or to receive a status of each one of the accounts.

Optionally, the payment system 100 manages a prepaid and a postpaid accounts for subscribers who use a single card as a credit and/or debit card (associated with the postpaid account) and as a prepaid card (associated with the prepaid account) and/or two physically separated cards, one as a credit and/or debit card (associated with the postpaid account) and the other as a prepaid card (associated with the prepaid account). In use, the subscriber uses his single card and/or two cards for performing prepaid and/or postpaid financial transactions. When two separate cards are used, the user card selection is indicative of the account he prefers to credit and/or to debit.

The payment system 100 optionally functions as a payment engine that consolidates a number of postpaid and prepaid accounts, for example card numbers, of a certain subscriber and routes postpaid and prepaid payments according to a respective set of accounts management rules.

The payment system 100 may be managed as an issuer system that manages prepaid and/or postpaid transactions of each of a plurality of subscribers. In such embodiments, the postpaid and prepaid accounts may be managed as features of a common account. In such embodiments, the postpaid account is the credit line which is given to a subscriber, optionally based on his prepaid account, which is managed as a current account. These accounts may also be managed as separate accounts which have a common identifier, for example as described below.

The payment system 100 includes or connected to a subscriber database 101 that associates between the postpaid account and the prepaid account of each subscriber, for example by a hash table, a vector of pointers and/or any suitable accounts dataset. The subscriber database 101 may be the subscriber database 101 of the issuer.

For example, the accounts dataset includes a plurality of subscriber records. Each subscriber record includes a unique subscriber identifier, such as an identification (ID) number, one or more postpaid account identifiers for example debit and/or credit card numbers, each indicative of a debit or a credit account or reference(s) thereto and a prepaid account identifier, for example a numeric value. It should be noted that any bank card number may be used, for example see ISO/IEC 7812, which is incorporated herein by reference. The modules of the payment system 100 are optionally operated with the assistance of a processor 109, for example as known in the art.

The accounts may be locally managed by an account management module 102.

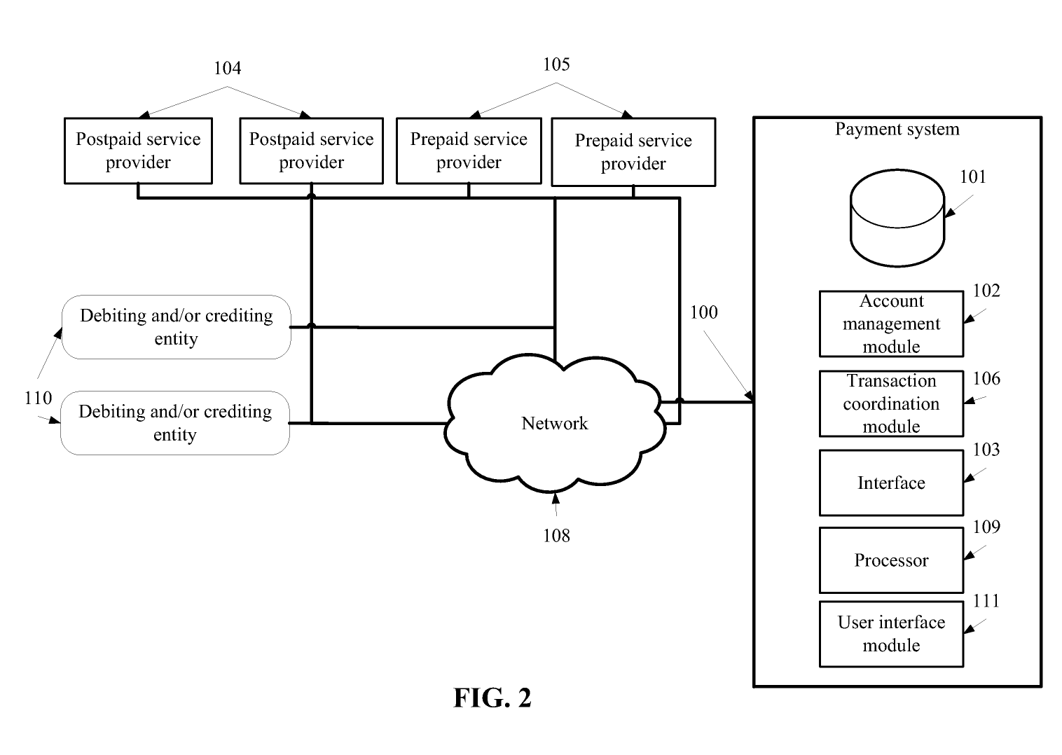

Additionally or alternatively, the payment system 100 may be used as a proxy that provides the logic for determining whether to perform a financial transaction using a prepaid service provider or a postpaid service provider. In such an embodiment, the financial transaction is forwarded to the provider which is selected according to the transaction coordination module 106. For example, reference is now also made to FIG. 2, which is a schematic illustration of the payment system 100 which is used for routing financial transactions based on rules, according to some embodiments of the present invention. The system us as described in FIG. 1; however, in this embodiments the system 100 includes an interface 103 that routes transactions to postpaid and prepaid providers instead of actually performing them. In such embodiments, the accounts externally managed by third party systems. The interface 103, which may be a network card (NEC), is used for communicating with gateways of systems of credit or debit card service providers, referred to herein as postpaid service providers 104 and/or systems of prepaid service providers 105 according to the subscriber records in the subscriber database 101 via a network 108, such as the Internet or an Ethernet.

The communication with the service providers 104, 105 is performed in a secured communication, as known in the art, for acquiring subscriber data.

It should be noted that as the subscriber database 101 associates between prepaid and postpaid accounts, existing accounts may be added to the payment system 100, for example based on existing prepaid and/or postpaid account identifiers. For example, a credit card number of a certain subscriber may be used as an identifier for debiting and/or crediting a prepaid account using the above subscriber database 101. In such embodiments, issuer identification number (IIN), also known as bank identification number (BIN), of the card remains as is.

The payment system 100 allows using a postpaid card, such as a credit card and/or a debit card, either existing and/or new, as dual account card that supports financial transactions involving crediting and/or debiting prepaid and/or postpaid accounts. The credit and/or debit card number is used as an identifier for both the prepaid and the postpaid accounts which are credited and/or debited according to a respective set of accounts management rules, for example as described herein.

According to some embodiments of the present invention, each of some or all of the subscriber records in the subscriber database 101 includes a set of accounts management rules defining under which circumstances to credit and/or to debit the postpaid account and under which circumstances to credit and/or to debit the prepaid account of a respective subscriber, for example as described below. Additionally or alternatively, general and/or group related set of accounts management rules are defined and used for selecting which account to debit and/or to credit and when. In such an embodiment, the accounts management rules may be selected per subscriber according to one or more characteristics thereof, for example according to purchase history, age, gender, credit rating, owned card types, and/or the like. Additionally or alternatively, when the user is about to perform a financial transaction with his dual account card, it determines whether to debit or credit the postpaid account or prepaid account.

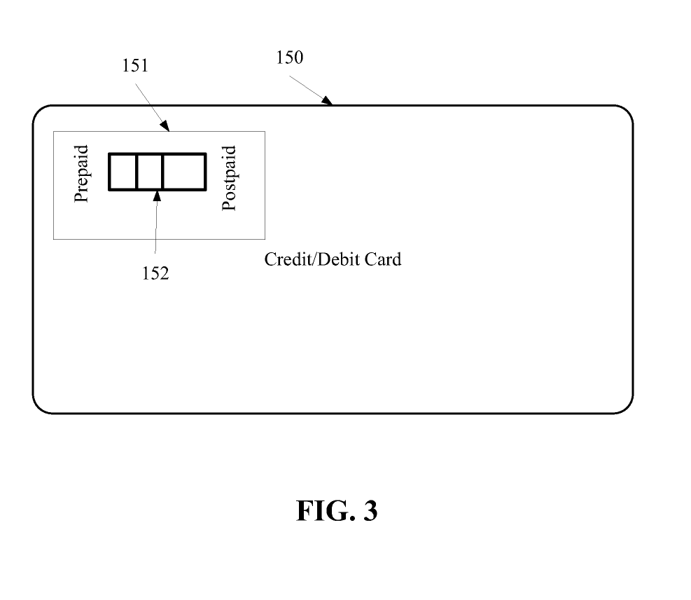

Optionally, the determination is made using a user interface that is embedded on the dual account card. For example, the dual account card is a dual-function type of credit card that as one or more buttons embedded therein to allow a subscriber to choose whether to pay with his postpaid account, for example from a credit card, or prepaid account, for example from a bank account. For example, FIG. 3 depicts a plastic transaction card 150 that has an embedded, optionally flexible, user selection component 151, such as an electronic circuit. The user selection component 151 may include a user interface, such as a switch 152, which allows a user to select between prepaid and postpaid account, optionally a microprocessor for processing the user selection and a wireless transmission circuitry for transmitting the user selection, for example an radio frequency identification (RFID) tag, and/or a mechanical means for indicating the user selection, for example a movable projection (i.e. the user switch itself). The design of the optional electronic circuit is well known and within the capability of those skilled in the art.

Optionally, the determination is made at a user interface that is embedded in a credit card swiping machine. In such embodiments, the operator of the credit card swiping machine, which is the subscriber and/or the seller, may input instructions indicative of an account selected for an ongoing transaction.

The payment system 100 further includes a transaction coordination module 106 which receives financial transaction requests via the network 108, for example directly from a debiting and/or crediting entity 110, and/or indirectly via one of the postpaid systems 104 and/or the prepaid services systems 105. In use, the transaction coordination module 106 manages the debiting and/or the crediting of the accounts of the subscribers. When a financial transaction request pertaining to a certain subscriber is received, a set of accounts management rules pertaining to the certain subscriber is identified. Then, postpaid and/or prepaid accounts are credited and/or debited in an automatic manner according to the set of accounts management rules, for example as described below.

According to some embodiments of the present invention, the payment system 100 manages the prepaid accounts locally, for example for one or more issuers. In such embodiments, the payment system 100 includes a loading module that allows crediting the prepaid accounts. The loading module may receive instructions to credit and/or to debit a subscriber in the manner a bank account is credited, for example by an electric fund transfer (EFT), such as a wire transfer, a direct deposit, a bank account transfer, a standing order and/or the like.

Optionally, the payment system 100 further includes a user interface module 111 that allows subscribers to define one or more accounts management rules. The user interface module optionally manages a webpage that includes a graphical user interface (GUI) that allows personalizing the accounts management rules, for example as described herein.

Optionally, the resources in the prepaid account are used as securities for the postpaid accounts. Optionally, the resources in the prepaid account may be transferred to another prepaid account and/or a bank account upon request. Optionally, the prepaid account and the postpaid account provide a closed financial cycle of expenses and incomes which are not connected to any other account. For example, this closed financial cycle is not connected to a bank account.

Optionally, the prepaid account and the postpaid account are managed in a different currency. For example, while one account is managed in U.S. dollars, the other is managed in Euros. In such an embodiment, the account for debiting may be automatically selected according to a geographic origin accounts management rule and/or charged currency accounts management rule, for example as defined below. In such an embodiment, the prepaid account may be charged in advance with board and lodging fee that is adapted to a visited country. Optionally, the prepaid account is charged with resources, such as money and/or points, for purchasing in a certain district, for example a university campus, a retail store, and/or a customer club stores.

Optionally, the prepaid account is charged with a purchased credit to pay for mobile phone and/or internet access services. In such embodiments, the prepaid account may be identified according to a cellular phone number.

Optionally, some or all of the resources in the prepaid account which are associated with one subscriber may be automatically transferred to a prepaid account which is associated with another subscriber. The transfer may be between local subscribers and/or as remittances.

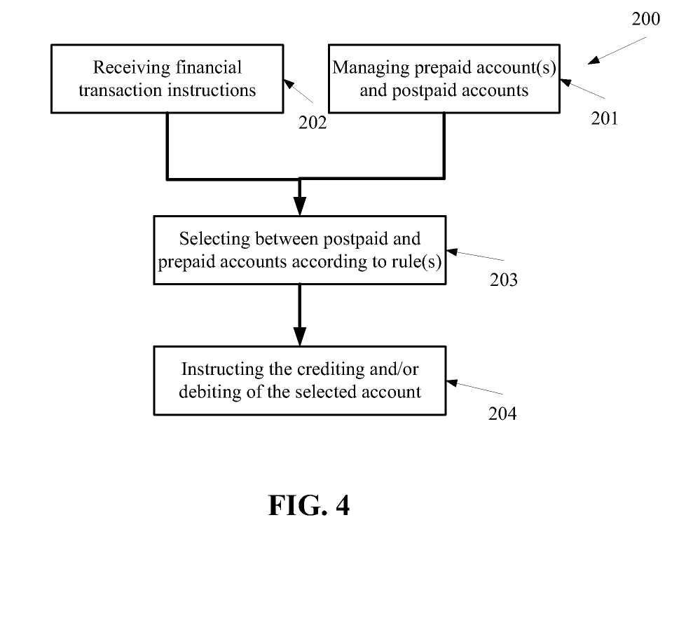

Reference is now also made to FIG. 4, which is a flowchart 200 of method of managing postpaid and prepaid accounts, according to some embodiments of the present invention. The method is optionally implemented using the above payment system 100.

As shown at 201, the method is based managing one or more prepaid accounts and one or more postpaid accounts for each of a plurality of subscribers, for example each of the subscribers documented in the subscriber database 101. As exemplified above, each subscriber is also associated with a common identifier, for example a credit card number, and one or more accounts management rules. For example, the following are a set of exemplary accounts management rules that may either be defined by the subscriber and/or automatically by the payment system 100, for example on behalf of the card issuer:
1. Source based financial transaction rule—a rule that defines to which account to transfer resources which are received from an identified entity and/or from an identified function. For example, resources received from an employer are transferred to the debit account.
2. Purchasing based financial transaction rule—a rule that defines which account to debit for an identified acquisition and/or for an identified function, for example for cash withdrawal the prepaid account is debited. This rule may define that the account to debit is selected according to a nature of a respective financial transaction, for example purchasing a product, purchasing a service, purchasing in payments, purchasing a service that is renewed every period, for example every month, money transfer, fund transfer, and/or the like.
3. Balance management rule—a rule that determines how and/or when a balance in one account is transferred to another account, for example for covering a deficit, gaining interest profit and/or the like.
4. Interest rules—a rule that defines the interest which is accumulated for a balance of one or more of the accounts.
5. Geographic origin/currency rule—a rule that determines which account should be charged for financial transaction based on its origin and/or currency.
6. Split debit/credit rule—a rule that determines how to split a credit and/or a debit among the accounts and/or under which circumstances.
7. Issuer rule—a rule that is defined by an issuer based on information pertaining to a subscriber, for example credit line and usage history.
8. Time based rule—a rule that determines which account should be charged for according to the time of the day, day of the week, date of the month, and date in a year.
9. Amount based rule—a rule that determines which account should be charged for according to the amount of the transaction, for example above and/or below a threshold.

The accounts management rules may be combined. For example, if a purchasing based financial transaction rule is met, a balance in one account is transferred to another account (Balance management rule). Another example is a rule, such as a purchasing based financial transaction rule that depends on the time and/or location of the financial transaction.

The accounts management rules may be personalized, namely associated with the subscriber and/or general, for example associated with a group and/or apply to all subscribers, as described above. As shown at 202, payment instructions to debit and/or to credit one of the subscribers is received, for example directly from a debiting and/or crediting entity, or indirectly, optionally via a respective interface, as described above.

Optionally, the accounts management rules are dynamic accounts management rules which are adjusted according to the balance of one or more of the accounts. As used herein, a balance of a credit account is optionally based on the undertakings of the subscribers in light of his credit line.

As shown at 203, one of the accounts of the credited and/or debited subscriber is selected automatically according to the accounts management rule(s) which are associated therewith, for example by the transaction coordination module 106. This allows instructing the debiting and/or crediting the selected account according to the payment instructions, as shown at 204. Optionally, the instructions are transmitted via the network 109 to the respective service provider 104, 105.

Optionally, the debiting and/or the crediting of one account induce resource transfer to or from another account. For example, if a prepaid account is debited for a portion that exceeds its balance, a credit is automatically taken to cover the portion.

According to some embodiments of the present invention, the set of accounts management rules define when resources from one account are automatically transferred to another account.

It is expected that during the life of a patent maturing from this application many relevant systems and methods will be developed and the scope of the term a network, a client terminal a server, and a credit card is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computerized method of managing a plurality of postpaid and prepaid accounts, comprising:
managing, for each of a plurality of subscribers, a prepaid account and a postpaid account having a common identifier;
providing at least one accounts management rule that defines to which of said prepaid account and said postpaid account to transfer resources;
receiving payment instructions to credit a first of said plurality of subscribers, said payment instructions is associated with a respective said common identifier;
selecting automatically, using a processor, according to respective said at least one accounts management rule, which of respective said prepaid account and said postpaid account of said first subscriber to credit according to said payment instructions; and
updating said selected account according to said payment instructions;
wherein said common identifier is a card number of said postpaid account.

2. The method of claim 1, wherein said common identifier is a credit card number of said postpaid account.

3. The method of claim 1, further comprising allowing a respective subscriber of said plurality of subscribers to personalize a respective said at least one accounts management rule.

4. The method of claim 1, further comprising identifying at least one characteristic of a respective subscriber of said plurality of subscribers and automatically personalizing a respective said at least one accounts management rule.

5. The method of claim 1, further comprising monitoring a balance in a first of said prepaid account and said postpaid account to detect a deviation from a credit amount and automatically generating said payment instructions to debit a second of said prepaid account and said postpaid account for crediting said first of said prepaid account and said postpaid account.

6. The method of claim 1, further comprising charging a respective said prepaid account for service usage by an associated subscriber of said plurality of subscribers.

7. The method of claim 1, wherein said prepaid account is used for as a credit account for purchasing by an associated subscriber of said plurality of subscribers in at least one preselected merchant.

8. The method of claim 1, wherein said prepaid account and said postpaid account are managed in different currencies.

9. The method of claim 1, wherein said managing further comprises managing for each of said plurality of subscribers a plurality of different prepaid accounts identified by said common identifier.

10. The method of claim 9, wherein each said prepaid account is associated with another of a plurality of merchants.

11. The method of claim 1, wherein said at least one accounts management rule comprises a conditional rule which is applied according to an analysis of a balance in at least one of said prepaid account and said postpaid account.

12. The method of claim 1, wherein said at least one accounts management rule defines which of said accounts to credit or debit according to the geographic location of a financial transaction inducing said payment instructions.

13. The method of claim 1, wherein said at least one accounts management rule defines how to split said resources or a debit among said accounts.

14. The method of claim 1, wherein said at least one accounts management rule defines which of said accounts to credit or debit according to the currency of a financial transaction inducing said payment instructions.

15. The method of claim 1, wherein said at least one accounts management rule defines which of said accounts to credit or debit according to a party of a financial transaction inducing said payment instructions.

16. A computer readable medium comprising computer executable instructions adapted to perform the method of claim 1.

17. A payment system of managing a plurality of postpaid and prepaid accounts, comprising:
a subscriber database adapted to document, for each of a plurality of subscribers, a prepaid account and a postpaid account having a common identifier and at least one accounts management rule that defines to which of said prepaid account and said postpaid account to transfer resources based on a source of said resources;
a payment monitoring module adapted to receive payment instructions to credit a first of said plurality of subscribers said payment instructions having a respective said common identifier; and
a transaction coordination module adapted to select automatically, according to respective said at least one accounts management rule, which of respective said prepaid account and said postpaid account of said first subscriber to credit according to said payment instructions;
wherein said selected account is updated according to said payment Instructions;
wherein said common identifier is a card number of aid postpaid account.

18. The system of claim 17, wherein at least one of said prepaid account and said postpaid account is managed by an external service provider system, said payment system further comprises an interface which updates said selected account by transmitting a message to said service provider system over a network.

19. The system of claim 17, wherein said payment monitoring module receives said payment instructions from an external service provider system.

20. (canceled)

21. The system of claim 17, further comprising a user interface module which allows a respective subscriber of said plurality of subscribers to personalize a respective said at least one accounts management rule.

22. A computerized method of managing a plurality of postpaid and prepaid accounts, comprising:
managing, for each of a plurality of subscribers, a prepaid account and a postpaid account having a common identifier;
providing at least one accounts management rule;
monitoring a balance in said prepaid account and said postpaid account; and
automatically transferring resources between said prepaid account and said postpaid account according to said at least one accounts management rule.

23. The method of claim 1, wherein said at least one accounts management rule comprises a conditional rule which is applied according to an analysis of the time of a transaction defined in said payment instructions.

24. The method of claim 1, wherein based on a source of said resources.
